(19) United States
(12) Patent Application Publication
(10) Pub. No.: US 2022/0412060 A1
(43) Pub. Date: Dec. 29, 2022

(54) EDGE PLATE REMOVAL SYSTEM

(71) Applicant: Caterpillar Inc., Peoria, IL (US)

(72) Inventors: Michael Rodney JACOBUS, Princeville, IL (US); Christopher James SORENSEN, Brimfield, IL (US); Andrew JOCHUMS, Manito, IL (US)

(73) Assignee: Caterpillar Inc., Peoria, IL (US)

(21) Appl. No.: 17/304,804

(22) Filed: Jun. 25, 2021

(51) Int. Cl. E02F 9/28; B23Q 1/44

(52) U.S. Cl. CPC E02F 9/2891; B23Q 1/44; E02F 9/2883

(57) ABSTRACT

An edge plate removal system includes a frame, a set of alignment rods attached to the frame, a set of clamping assemblies attached to the frame, a handle attached to the frame, and a set of lift points attached to the frame. Each alignment rod, of the set of alignment rods, is configured to be inserted into a bore of an edge plate (e.g., a cutting edge) of an implement (e.g., a blade) of a machine. Each clamping assembly, of the set of clamping assemblies, is configured to clamp the edge plate and includes a first clamp and a second clamp, a clamp rod, a set of retention nuts, and a set of tightening nuts. The handle and the set of lift points are configured to facilitate application of a pulling force on the edge plate when the edge plate is clamped by the clamping assembly.

### TECHNICAL FIELD

The present disclosure relates generally to a system for removing an edge plate from an implement of a machine and, for example, to a cutting edge removal system for removing a cutting edge from a blade of a machine.

### BACKGROUND

Earthmoving machines, such as track-type tractors, may be used to perform displacement, distribution, and leveling of material, such as soil. A track-type tractor typically employs a blade assembly that includes a blade and a cutting edge that is attached to the blade. As the track-type tractor moves along a surface of material, the cutting edge penetrates the surface to permit the blade assembly to displace the material. During operation, the blade assembly scrapes the surface and is also impacted by debris, such as soil, gravel, rock, and organic material (e.g., plant material), resulting in wear to the cutting edge. Accordingly, frequent replacement of the cutting edge may be necessary. Replacement of the cutting edge is difficult and time consuming, thereby negatively impacting efficiency and speed of earthmoving operations.

U.S. Pat. No. 6,241,227 (the '227 patent) discloses a device for handling replaceable plates, such as cutting edges and wear plates, used on the blades of plows and graders. Per the '227 patent, the device is a cart for handling the replaceable plates and includes a wheeled frame and a plate holder supported on the frame for up and down movement relative to the ground. The plate holder is designed to support a plate in an orientation generally corresponding to the front face of the blade.

However, many worksites have different terrain conditions (e.g., non-level terrains) that require a robust solution for removing and replacing a cutting edge. Further, in some cases, a cutting edge has two cutting edge surfaces and, after a first cutting edge surface becomes worn, the cutting edge can be removed, rotated upside-down, and reattached to expose a second cutting edge surface to a work surface. Accordingly, a system is required that can support each of removal, reorientation, and reattachment of a cutting edge. The edge plate removal system of the present disclosure solves one or more of the problems set forth above and/or other problems in the art.

### SUMMARY

In some implementations, a cutting edge removal system includes a frame; a set of alignment rods attached to the frame; a set of clamping assemblies attached to the frame; a handle attached to the frame; and a set of lift points attached to the frame, wherein: each alignment rod, of the set of alignment rods, is configured to be inserted into a bore of a cutting edge of a blade of a machine, each clamping assembly, of the set of clamping assemblies, is configured to clamp the cutting edge, the handle is configured to facilitate application of a pulling force on the cutting edge when the cutting edge is clamped by the clamping assembly, and the set of lift points is configured to attach to a lifting device to facilitate application of the pulling force on the cutting edge when the cutting edge is clamped by the clamping assembly.

In some implementations, an edge plate removal device includes a set of alignment rods attached to a frame of the edge plate removal device; a set of clamping assemblies attached to the frame; and a set of pulling components attached to the frame, wherein: each alignment rod, of the set of alignment rods, is configured to be inserted into a bore of an edge plate of an implement of a machine, each clamping assembly, of the set of clamping assemblies, is configured to clamp the edge plate, and each pulling component, of the set of pulling components, is configured to facilitate application of a pulling force on the edge plate when the edge plate is clamped by the clamping assembly.

In some implementations, a clamping assembly includes a first clamp that is configured to contact a first region of an edge plate; a second clamp that is configured to contact a second region of the edge plate; a clamp rod that is configured to extend through a hole of the first clamp, a bore of a frame of an edge plate removal device, and a hole of the second clamp; a set of retention nuts that are configured to facilitate attachment of the clamp rod to the frame; and a set of tightening nuts configured to adjust respective positions of the first clamp and the second clamp on the clamp rod.

### BRIEF DESCRIPTION OF THE DRAWINGS

FIG. 1 is a diagram of an example machine described herein.

FIGS. 2A-2D are diagrams of an example edge plate removal system.

FIG. 3 is diagram of an example clamping assembly described herein.

FIG. 4 is diagram of an example alignment rod in an alignment rod holder.

### DETAILED DESCRIPTION

This disclosure relates to a system for removing an edge plate, such as a cutting edge, from an implement, which is applicable to any machine that needs removal of an edge plate. The term “machine” may refer to any machine that performs an operation associated with an industry such as, for example, mining, construction, farming, transportation, or another industry. For example, the machine may be an earth-moving machine or material-moving machine, such as an excavator, a wheel loader, or a track-type tractor and loader, among other examples.

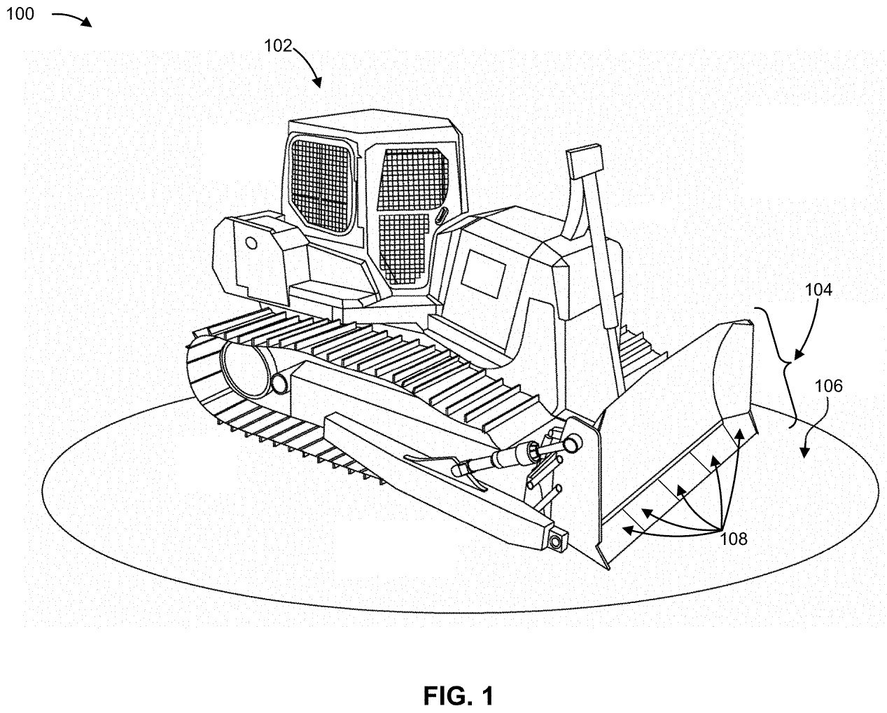

FIG. 1 is a diagram 100 of an example machine 102, which may be an earth moving machine such as a track type tractor or dozer, a motor grader, or a similar machine. The machine 102 may include an implement 104 that is configured to engage, penetrate, or cut a ground surface 106 of a worksite and may be further configured to move earth or another material to accomplish a task. Moving the earth may be associated with altering a topography of the ground surface 106 at the worksite and may include, for example, a grading operation, a scraping operation, a leveling operation, a material removal operation, or any other type of geography altering operation at the worksite. The implement 104 may include one or more edge plates 108 that are attached (e.g., via respective sets of bolts) to a surface of the implement 104 and that are configured to facilitate moving the earth and/or to protect the implement 104 from damage when moving the earth. For example, as shown in FIG. 1, the implement 104 may be a blade and each of the one or more edge plates 108 may be a cutting edge.

When an edge plate 108 is a cutting edge, the edge plate 108 may have a first cutting edge surface and a second cutting edge surface (e.g., on opposite sides of the edge plate 108). The edge plate 108 may be initially attached to the implement 104 such that the first cutting edge surface is proximate to the ground surface 106, which may cause the first cutting edge surface to become worn. Accordingly, the edge plate 108 then may be removed from the implement 104, turned upside-down, and reattached to the implement 104 such that the second cutting edge surface (e.g., that is not worn) is proximate to the ground surface. In this way, a single edge plate 108 may be used, instead of using multiple edge plates 108, during a period associated with a geography altering operation.

As indicated above, FIG. 1 is provided as an example. Other examples may differ from what is described in connection with FIG. 1.

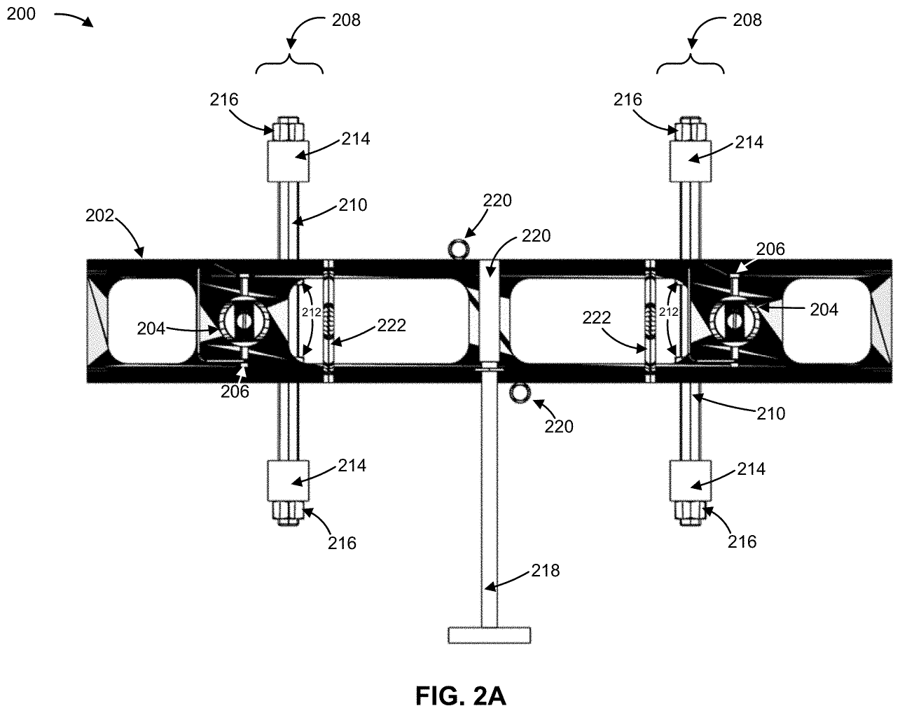

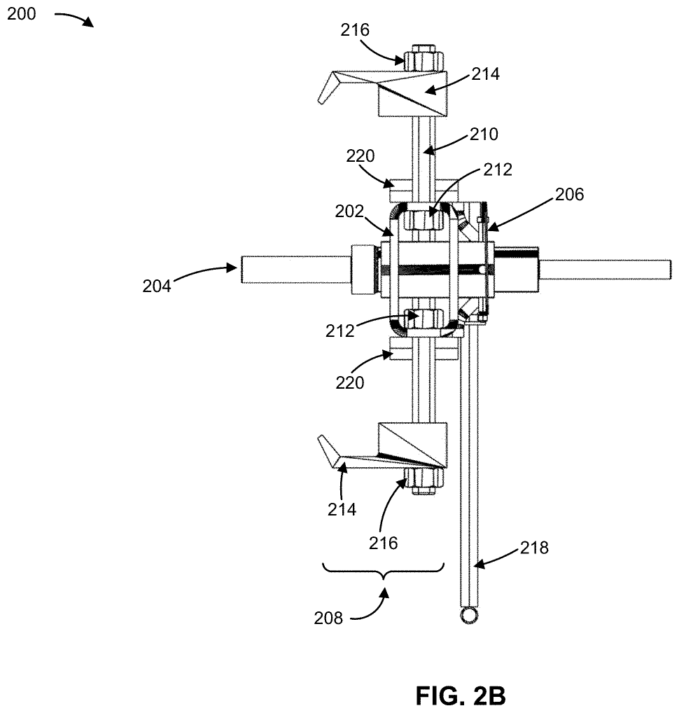

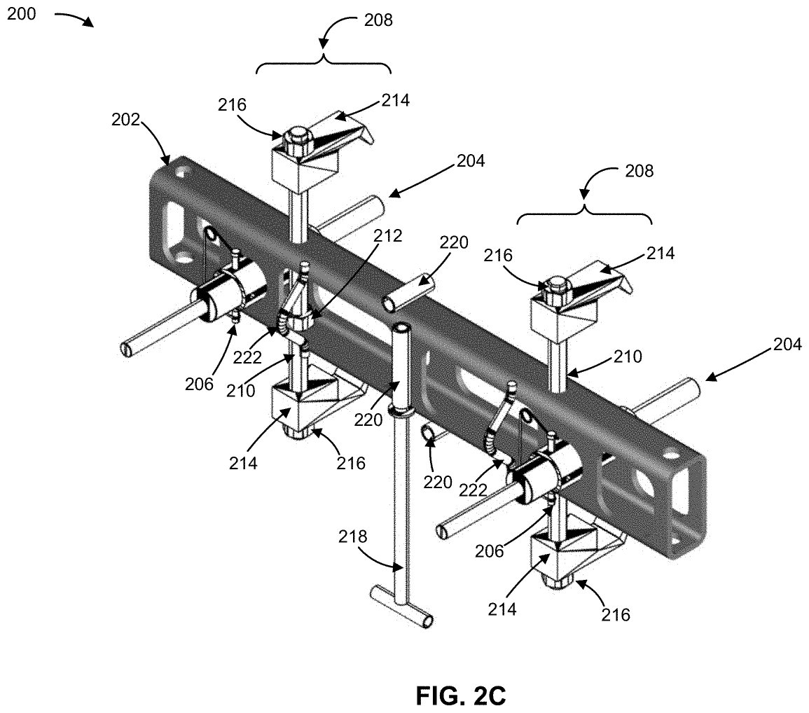

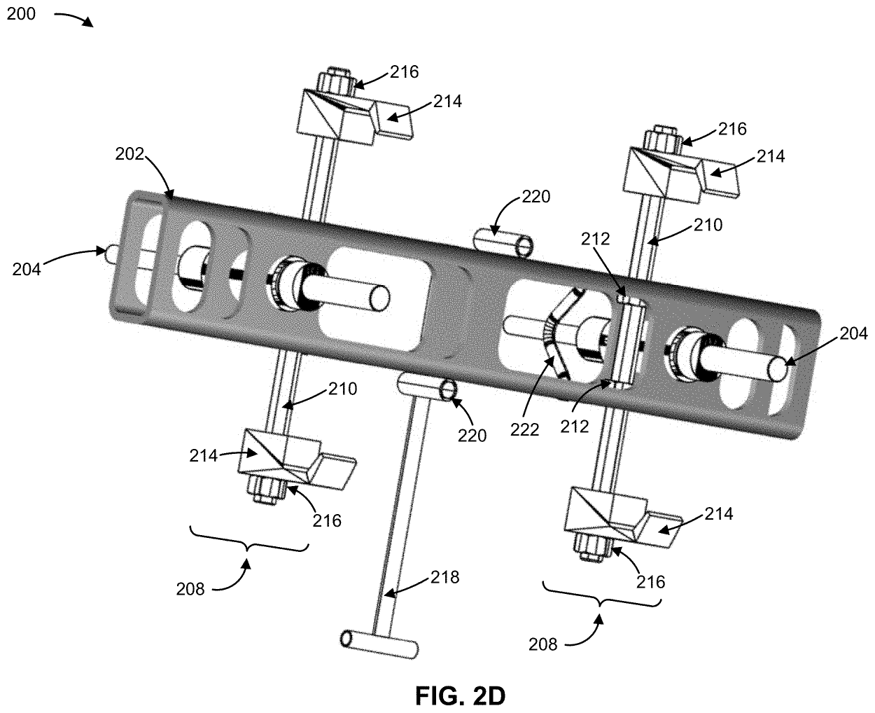

FIGS. 2A-2D are diagrams of an example edge plate removal system 200 (also referred to as a cutting edge removal system, an edge plate removal device, or a cutting edge removal device, among other examples) described herein. The edge plate removal system 200 may be used to remove, or to facilitate removal, of an edge plate 108, of the one or more edge plates 108, from the implement 104 of the machine 102. For example, the edge plate removal system 200 may be a cutting edge removal system and may be used to remove a cutting edge from a blade of a machine. FIG. 2A is a back view of the edge plate removal system 200. FIG. 2B is a side view of the edge plate removal system 200. FIG. 2C is an angled back view of the edge plate removal system 200. FIG. 2D is an angled front view of the edge plate removal system 200.

As shown in FIGS. 2A-2D, the edge plate removal system 200 may include a frame 202; a set of alignment rods 204 (e.g., two or more alignment rods 204); a set of retention pins 206 (e.g., two or more retention pins 206); a set of clamping assemblies 208 (e.g., two or more clamping assemblies 208), wherein each clamping assembly 208 includes a clamp rod 210, a set of retention nuts 212 (e.g., two or more retention nuts 212), a set of clamps 214 (e.g., two or more clamps 214), and/or a set of tightening nuts 216 (e.g., two or more tightening nuts 216); a handle 218; a set of handle holders 220 (e.g., one or more handle holders 220); and/or a set of lift points 222 (e.g., one or more lift points 222).

The frame 202 may provide a physical structure to support one or more of the other components of the edge plate removal system 200, as described herein. In some implementations, the frame 202 may comprise steel or a similarly strong material.

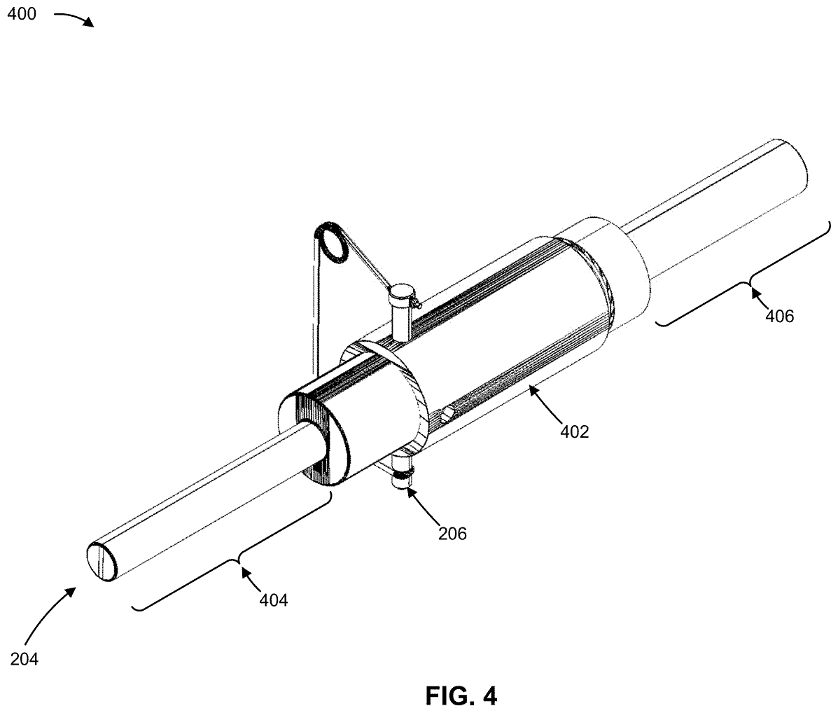

The set of alignment rods 204 may be attached to the frame 202. For example, each alignment rod 204, of the set of alignment rods 204, may extend through a respective bore of the frame 202, and a respective retention pin 206, of the set of retention pins 206, may be used to “lock” the alignment rod 204 within the bore of the frame 202. Additionally, or alternatively, an alignment rod 204 may include a retention hole (e.g., that passes through a horizontal axis of the alignment rod), a bore of the frame 202 may include an alignment rod holder (e.g., an alignment rod holder 402, as described herein in relation to FIG. 4) that includes a retention hole that aligns with the retention hole of the alignment rod 204 when the alignment rod 204 is inserted into the alignment rod holder, and a retention pin 206 may be inserted into the retention hole of the alignment rod 204 and the retention hole of the alignment rod holder. In this way, the retention pin 206 may be configured to facilitate placement of the alignment rod 204 within the alignment rod holder and/or the bore of the frame 202.

The set of alignment rods 204 may be configured to be inserted into corresponding bores of an edge plate 108 of the one or more edge plates 108 (e.g., corresponding bores of a cutting edge). For example, an edge plate 108 may include a plurality of bores in which a plurality of bolts are respectively inserted to attach the edge plate 108 to the implement 104 (e.g., to attach the cutting edge to a blade). A set of bolts, of the plurality of bolts, may be removed from a set of bores, of the plurality of bores, and the set of alignment rods 204 may be respectively inserted into the set of bores (e.g., with assistance of a lifting device described herein). In this way, by being inserted into the set of bores, the set of alignment rods 204 facilitate alignment of the edge plate removal system 200 with the edge plate 108 and/or the implement 104.

The set of clamping assemblies 208 may be attached to the frame 202. For example, the clamp rod 210 of each clamping assembly 208, of the set of clamping assemblies 208, may be a threaded rod that is inserted into one or more bores of the frame 202, and the set of retention nuts 212 of the clamping assembly 208 may be threaded and positioned on the clamp rod 210 to cause the clamp rod 210 to be locked within the one or more bores of the frame 202. Accordingly, the set of retention nuts 212 may be configured to facilitate attachment of the clamp rod 210 and the clamp assembly 208 to the frame 202.

Each clamping assembly 208 may include a set of clamps 214 and a set of tightening nuts 216 positioned on the clamp rod 210 of the clamping assembly 208. For example, as shown in FIGS. 2A-2D, a first clamp 214 and a first tightening nut 216 may be positioned on a first portion of a clamp rod 210 (e.g., a top portion of the clamp rod 210 that extends beyond the frame 202) and a second clamp 214 and a second tightening nut 216 may be positioned on a second portion of the clamp rod 210 (e.g., a bottom portion of the clamp rod 210 that extends beyond the frame 202). The first clamp 214 may include a hole through which the first portion of the clamp rod 210 extends, and the second clamp 214 may include a hole through with the second portion of the clamp rod extends. Accordingly, the clamp rod 210 may be configured to extend through the hole of the first clamp, the one or more bores of the frame 202, and/or the hole of the second clamp 214.

The set of clamps 214 may be configured to contact respective regions of the edge plate 108 (e.g., when the set of alignment rods 204 are inserted into respective bores of the edge plate 108). For example, the first clamp 214 may be configured to contact a first region of the edge plate 108 (e.g., a top surface of the edge plate 108), and the second clamp 214 may be configured to contact a second region of the edge plate 108 (e.g., a bottom surface of the edge plate 108). The set of tightening nuts 216 may be configured to adjust respective positions of the set of clamps 214. For example, the first tightening nut 216 may be rotated about the clamp rod 210 to adjust a position of the first clamp 214 on the first portion of the clamp rod 210, and the second tightening nut 216 may be rotated about the clamp rod 210 to adjust a position of the second clamp 214 on the second portion of the clamp rod 210.

Accordingly, the set of tightening nuts 216 may be configured to cause the set of clamps 214 to contact respective regions of the edge plate 108. For example, the first tightening nut 216 may be rotated about the clamp rod 210 to adjust a position of the first clamp 214 to cause the first clamp 214 to contact the first region of the edge plate 108, and/or the second tightening nut 216 may be rotated about the clamp rod 210 to adjust a position of the second clamp 214 to cause the second clamp 214 to contact the second region of the edge plate 108. In this way, the clamping assembly 208 may be configured to apply a clamping force (e.g., via the set of clamps 214). For example, the first clamp 214 and the second clamp 214 may exert a clamping force when the first clamp 214 contacts the first region of the edge plate 108 and the second clamp 214 contacts the second region of the edge plate 108. In some implementations, the clamping force may be between 800 and 1000 newtons.

The handle 218 may attach to the frame 202 via a handle holder 220 of the set of handle holders 220. For example, the handle 218 may comprise a shaft that is able to be inserted into each handle holder 220 of the set of handle holders 220. The set of handle holders 220 may be attached to the frame (e.g. welded to the frame 202) at respective locations of the frame 202. Accordingly, the shaft of the handle 218 may be inserted into a particular handle holder 220, of the set of handle holders 220, to attach the handle 218 to the frame 202 and to hold the handle 218 at a particular orientation to the frame 202. Additionally, or alternatively, the handle 218 may be configured to facilitate application of a pulling force on the edge plate 108 (e.g., when the edge plate 108 is clamped by the set of clamping assemblies 208). For example, the handle 218 may include a handle bar with which an operator of the edge plate removal system 200 can interact to apply a pulling force on the edge plate 108 when the shaft of the handle 218 is inserted into the particular handle holder 220 and the handle 218 is held at the particular orientation to the frame 202.

The set of lift points 222 may be attached to the frame 202 (e.g., welded to the frame 202). Each lift point 222, of the set of lift points 222, may be configured to attach to a lifting device (e.g., a boom of a crane) via rigging or other supporting material. For example, the lift point 222 may comprise a metal loop (e.g., a rounded loop) to which the rigging or other supporting material can be connected. Accordingly, the edge plate removal system 200 may be suspended proximate to the edge plate 108 by the lifting device via the set of lift points 222. Additionally, or alternatively, the set of lift points 222 may be configured to facilitate application of a pulling force on the edge plate 108 (e.g., when the edge plate 108 is clamped by the clamping assembly 208). For example, an operator of the lifting device may engage the lifting device to cause the rigging to apply a pulling force on the set of lift points 222, which applies the pulling force on the edge plate 108 (e.g., because the set of lift points 222 are attached to the frame 202).

In an example use case, an operator of the edge plate removal system 200 may attach rigging to the set of lift points 222 and operate a lifting device to lift and move the edge plate removal system 200 proximate to an edge plate 108 (e.g., a cutting edge) that is to be removed from an implement 104 (e.g., a blade). The operator may remove a set of bolts from a set of bores of the edge plate 108 (e.g. that attach the edge plate 108 to the implement 104) and may insert the handle 218 into a handle holder 220 of the set of handle holders 220. The operator may interact with the handle 218 and/or operate the lifting device to move the edge plate removal system 200 and thereby cause the set of alignment rods 204 to insert into the set of bores of the edge plate 108.

After the edge plate removal system 200 is aligned with the edge plate 108 (e.g. via the set of alignment rods 204 inserted into the set of bores of the edge plate 108), the operator may interact with the set of tightening nuts 216 of each clamping assembly 208, of the set of clamping assemblies 208, to cause the set of clamps 214 of the clamping assembly 208 to clamp the edge plate 108. For example, the operator may rotate a first tightening nut 216, of the set of tightening nuts 216, on a clamp rod 210 of the clamping assembly 208 to cause a first clamp 214, of the set of clamps 214, to contact a first region of the edge plate 108 (e.g., a first lip and/or surface of the edge plate 108), and/or may rotate a second tightening nut 216, of the set of tightening nuts 216, on the clamp rod 210 to cause a second clamp 214, of the set of clamps 214, to contact a second region of the edge plate 108 (e.g., a second lip and/or surface of the edge plate 108). The operator may further interact with the set of tightening nuts 216 to cause the clamping assembly 208 to apply a particular clamping force on the edge plate 108 (e.g., via the set of clamps 214 contacting respective regions of the edge plate 108), such as a particular clamping force between 800 and 1000 newtons.

After the edge plate removal system 200 clamps the edge plate 108, the operator may remove any remaining bolts that attach the edge plate 108 to the implement 104. The operator then may interact with the handle 218 and/or operate the lifting device to apply a pulling force (e.g., via the handle 218 and/or the set of lift points 222) on the edge plate 108, which may lift the edge plate 108 and thereby cause the edge plate 108 to be removed from the implement 104.

After the edge plate 108 is removed from the implement 104, the operator may insert the handle 218 into another handle holder 220, of the set of handle holders 220, and may interact with the handle 218 to change an orientation of the edge plate removal system 200 (e.g., while the edge plate removal system 200 is suspended by the rigging via the set of lift points 222) and thereby cause the edge plate 108 to be oriented upside-down to the implement 104. The operator may interact with the handle 218 and/or operate the lifting device to move the edge plate removal system 200 and thereby cause the edge plate 108 to be positioned (e.g., upside-down) on the implement 104.

After the edge plate 108 is positioned on the implement 104, the operator may insert bolts into bores of the edge plate 108 to attach the edge plate 108 to the implement 104. The operator then may interact with the set of tightening nuts 216 of each clamping assembly 208, of the set of clamping assemblies 208, to cause the set of clamps 214 of the clamping assembly 208 to cease clamping the edge plate 108. For example, the operator may rotate the first tightening nut 216 on the clamp rod 210 of the clamping assembly 208 to cause the first clamp 214 to cease contacting the first region of the edge plate 108, and/or may rotate the second tightening nut 216 on the clamp rod 210 to cause the second clamp 214 to cease contacting the second region of the edge plate 108 (e.g., a second lip and/or surface of the edge plate 108). Accordingly, the clamping assembly 208 may cease applying a particular clamping force on the edge plate 108.

After the edge plate removal system 200 ceases clamping the edge plate 108, the operator may interact with the handle 218 and/or operate the lifting device to move the edge plate removal system 200 and thereby cause the set of alignment rods 204 to be removed from the set of bores of the edge plate 108. The operator then may insert bolts into the set of bores of the edge plate 108 and thereby securely attach the edge plate 108 to the implement 104. In this way, the edge plate removal system 200 can be used to remove an edge plate 108 from an implement 104, to flip the edge plate 108 upside-down, and to reinstall the edge plate 108 on the implement 104 in an upside-down orientation.

As indicated above, FIGS. 2A-2D are provided as an example. Other examples may differ from what is described in connection with FIGS. 2A-2D.

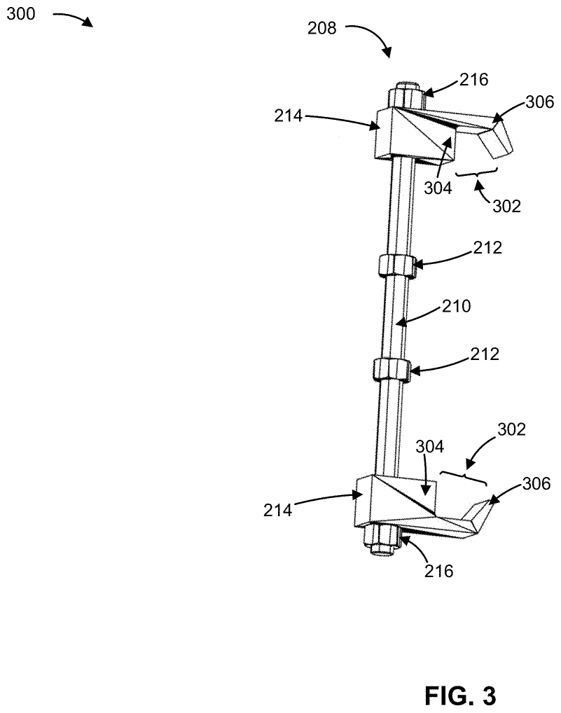

FIG. 3 is diagram 300 of an example clamping assembly 208. As shown in FIG. 3, the clamping assembly 208 may include a clamp rod 210, a set of retention nuts 212 (e.g., shown as two retention nuts 212), a set of clamps 214 (e.g., shown as two clamps 214), and/or a set of tightening nuts 216 (e.g., shown as two tightening nuts 216). As described above, the clamp rod 210 is configured to extend through respective holes of the set of clamps 214 and/or one or more bores of a frame 202 of an edge plate removal system 200. The clamp rod 210 may be threaded and the set of retention nuts 212 may also be threaded and may be configured to facilitate attachment of the clamp rod 210 to the frame 202. For example, a retention nut 212, of the set of retention nuts 212, may be rotated on the clamp rod 210 to cause the retention nut 212 to be disposed on a bore, of the one or more bores, of the frame 202 and thereby cause a portion of the clamp rod 210 to be held within the bore of the frame 202.

Each clamp 214 may be configured to contact a region of an edge plate 108. For example, each clamp 214 may include a clamping region 302 that is configured to contact the region of the edge plate 108. The clamping region 302 may be defined by one or more surfaces of the clamp 214. For example, as shown in FIG. 3, the clamping region 302 may be defined by a surface of a base 304 of the clamp 214 and the surfaces of a finger 306 of the clamp 214. The clamping region 302 may have a polygonal shape and/or a round shape (e.g., due to planar or curved surfaces of the clamp 214).

The set of tightening nuts 216 may be threaded and may be configured to adjust respective positions of the set of clamps 214 on the clamp rod 210. For example, a tightening nut 216, of the set of tightening nuts 216, may be rotated on the clamp rod 210 to cause the clamp 214 to move up or down the clamp rod 210. Accordingly, the set of tightening nuts 216 may be configured to facilitate the set of clamps 214 contacting respective regions of the edge plate 108.

As indicated above, FIG. 3 is provided as an example. Other examples may differ from what is described in connection with FIG. 3.

FIG. 4 is diagram 400 of an example alignment rod 204 in an alignment rod holder 402 (e.g., that is inserted into and attached to a bore of a frame 202 of an edge plate removal system 200). In some implementations, the edge plate removal system 200 may include a set of alignment rod holders that are respectively configured to hold the set of alignment rods 204 in the frame 202. For example, each alignment rod 204, of the set of alignment rods 204, may extend through a respective alignment rod holder 402 of the set of alignment rod holders 402. Further, each retention pin 206, of the set of retention pins 206, may facilitate placement of a portion of a respective alignment rod 204, of the set of alignment rods 204, in a respective alignment rod holder 402 of the set of alignment rod holders 402.

As shown in FIG. 4, the alignment rod 204 may extend through the alignment rod holder 402, with a first portion 404 of the alignment rod 204 extending past a first side of the alignment rod holder 402 and a second portion 406 of the alignment rod 204 extending past a second side of the alignment rod holder 402. The alignment rod 204 may include a retention hole (e.g., that passes through a horizontal axis of the alignment rod 204) and the alignment rod holder 402 may include a retention hole that aligns with the retention hole of the alignment rod 204 when the alignment rod 204 is inserted into the alignment rod holder 402. A retention pin 206 may be inserted into the retention hole of the alignment rod 204 and the retention hole of the alignment rod holder 402 and thereby cause a portion of the alignment rod 204 to be locked within the alignment rod holder 402. In this way, the retention pin 206 may be configured to facilitate placement of the alignment rod 204 within the alignment rod holder 402 (and/or the bore of the frame 202 in which the alignment rod holder is inserted).

As further shown in FIG. 4, the first portion 404 of the alignment rod 204 may have a first diameter and the second portion 406 of the alignment rod 204 may have a second diameter. The first diameter may be different than the second diameter (e.g., the first diameter may be less than the second diameter). Accordingly, the alignment rod 204 may be inserted into the alignment rod holder 402 such that an appropriately sized portion of the alignment rod 204 faces a bore of an edge plate 108 that is to be lifted by the edge plate removal system 200. For example, for an edge plate 108 with a bore that has a smaller diameter, the alignment rod 204 may be inserted into the alignment rod holder 402 such that the first portion 404 of the alignment rod 204 faces the bore of the edge plate 108. As another example, for an edge plate 108 with a bore that has a larger diameter, the alignment rod 204 may be inserted into the alignment rod holder 402 such that the second portion 406 of the alignment rod 204 faces the bore of the edge plate 108.

As indicated above, FIG. 4 is provided as an example. Other examples may differ from what is described in connection with FIG. 4.

### INDUSTRIAL APPLICABILITY

Some implementations described herein provide an edge plate removal system that enables removal of an edge plate (e.g., a cutting edge) from an implement (e.g., a blade) of a machine. The edge plate removal system includes a frame, a set of alignment rods, a set of clamping assemblies, and a set of pulling components. The set of alignment rods insert into corresponding bores of the edge plate and thereby cause the edge plate removal system to be aligned with the edge plate. When the edge plate removal system is aligned with the edge plate, the set of clamping assemblies (e.g., that respectively include a set of clamps on a clamp rod) clamp the edge plate. When the edge plate is clamped by the set of clamping assemblies, the set of pulling components (e.g., that include a handle and/or a set of lift points) facilitate application of a pulling force on the edge plate, which causes the edge plate to be removed from the implement.

In this way, a single operator may interact with the handle of the edge plate removal system, a lifting device that suspends the edge plate removal system via rigging connected to the set of lift points, and/or respective sets of tightening nuts of the sets of clamping assemblies to cause the edge plate to be removed from the implement. Accordingly, the edge plate removal system is able to quickly and efficiently remove edge plates that would otherwise be difficult and/or time consuming to remove using conventional removal techniques. Further, because the edge plate removal system utilizes a set of lift points to allow a lifting device to lift and move the edge plate removal system, the edge plate removal system can be used in any terrain condition (including uneven terrain). Additionally, the edge plate removal system is able to remove, reorient, and reattach an edge plate without releasing the edge plate, which is not possible using conventional removal techniques. This further conserves time and resources used to service the implement of the machine and/or promotes efficient operation of the machine.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “bottom,” “above,” “upper,” “top,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A cutting edge removal system, comprising:
a frame;
a set of alignment rods attached to the frame;
a set of clamping assemblies attached to the frame;
a handle attached to the frame; and
a set of lift points attached to the frame, wherein:
each alignment rod, of the set of alignment rods, is configured to be inserted into a bore of a cutting edge of a blade of a machine,
the set of clamping assemblies are configured to clamp the cutting edge,
the handle is configured to facilitate application of a pulling force on the cutting edge when the cutting edge is clamped by the set of clamping assemblies, and
the set of lift points is configured to attach to a lifting device to facilitate application of the pulling force on the cutting edge when the cutting edge is clamped by the set of clamping assemblies.

2. The cutting edge removal system of claim 1, wherein the alignment rod extends through an alignment rod holder of the frame.

3. The cutting edge removal system of claim 1, further comprising a retention pin,
wherein the retention pin is configured to facilitate placement of the alignment rod within an alignment rod holder of the frame.

4. The cutting edge removal system of claim 1, wherein each alignment rod, of the set of alignment rods, includes a first portion of the alignment rod and a second portion of the alignment rod, and wherein:
the first portion of the alignment rod has a first diameter; and
the second portion of the alignment rod has a second diameter,
wherein the first diameter is different than the second diameter.

5. The cutting edge removal system of claim 1, wherein each clamping assembly, of the set of clamping assemblies, includes:
a clamp rod;
a set of retention nuts configured to facilitate attachment of the clamp rod to the frame;
a first clamp that includes a hole through which a first portion of the clamp rod extends;
a second clamp that includes a hole through which a second portion of the clamp rod extends; and
a set of tightening nuts configured to adjust respective positions of the first clamp and the second clamp on the clamp rod.

6. The cutting edge removal system of claim 5, wherein:
a first tightening nut, of the set of tightening nuts, is configured to adjust a position of the first clamp to cause the first clamp to contact a first region of the cutting edge; and
a second tightening nut, of the set of tightening nuts, is configured to adjust a position of the second clamp to cause the second clamp to contact a second region of the cutting edge.

7. The cutting edge removal system of claim 1, wherein each clamping assembly, of the set of clamping assemblies, includes:
a first clamp that is configured to contact a first region of the cutting edge; and
a second clamp that is configured to contact a second region of the cutting edge,
wherein the clamping assembly is configured to apply a clamping force on the cutting edge when the first clamp contacts the first region of the cutting edge and the second clamp contacts the second region of the cutting edge.

8. The cutting edge removal system of claim 7, wherein the clamping force is between 800 and 1000 newtons.

9. The cutting edge removal system of claim 1, further comprising a handle holder,
wherein the handle holder holds the handle at a particular orientation to the frame,
wherein the particular orientation enables the handle to facilitate application of the pulling force on the cutting edge when the cutting edge is clamped by the set of clamping assemblies.

10. An edge plate removal device, comprising:
a set of alignment rods attached to a frame of the edge plate removal device;
a set of clamping assemblies attached to the frame; and
a set of pulling components attached to the frame, wherein:
each alignment rod, of the set of alignment rods, is configured to be inserted into
a bore of an edge plate of an implement of a machine,
each clamping assembly, of the set of clamping assemblies, is configured to clamp the edge plate, and
each pulling component, of the set of pulling components, is configured to facilitate application of a pulling force on the edge plate.

11. The edge plate removal device of claim 10, further comprising a set of alignment rod holders attached to the frame,
wherein each alignment rod, of the set of alignment rods, extends through a respective alignment rod holder of the set of alignment rod holders.

12. The edge plate removal device of claim 11, further comprising a set of retention pins,
wherein each retention pin, of the set of retention pins, facilitates placement of a portion of a respective alignment rod, of the set of alignment rods, in a respective alignment rod holder of the set of alignment rod holders.

13. The edge plate removal device of claim 10, wherein each alignment rod, of the set of alignment rods, includes a first portion of the alignment rod and a second portion of the alignment rod, and
wherein the first portion of the alignment rod has a diameter that is different than a diameter of the second portion of the alignment rod.

14. The edge plate removal device of claim 10, wherein each clamping assembly, of the set of clamping assemblies, includes:
a clamp rod;
a set of retention nuts configured to facilitate attachment of the clamp rod to the frame;
a first clamp that includes a hole through which a first portion of the clamp rod extends;
a second clamp that includes a hole through which a second portion of the clamp rod extends; and
a set of tightening nuts configured to adjust respective positions of the first clamp and the second clamp on the clamp rod.

15. The edge plate removal device of claim 14, wherein:
a first tightening nut, of the set of tightening nuts, is configured to adjust a position of the first clamp to cause the first clamp to contact a first region of the edge plate; and
a second tightening nut, of the set of tightening nuts, is configured to adjust a position of the second clamp to cause the second clamp to contact a second region of the edge plate.

16. The edge plate removal device of claim 10, wherein each clamping assembly, of the set of clamping assemblies, includes:
a first clamp that is configured to contact a first region of the edge plate; and
a second clamp that is configured to contact a second region of the edge plate,
wherein the clamping assembly is configured to apply a clamping force on the edge plate when the first clamp contacts the first region of the edge plate and the second clamp contacts the second region of the edge plate.

17. The edge plate removal device of claim 10, wherein the set of pulling components includes at least one of:
a handle; or
a set of lift points.

18. A clamping assembly, comprising:
a first clamp that is configured to contact a first region of an edge plate;
a second clamp that is configured to contact a second region of the edge plate;
a clamp rod that is configured to extend through a hole of the first clamp, a bore of a frame of an edge plate removal device, and a hole of the second clamp;
a set of retention nuts that are configured to facilitate attachment of the clamp rod to the frame; and
a set of tightening nuts configured to adjust respective positions of the first clamp and the second clamp on the clamp rod.

19. The clamping assembly of claim 18, wherein:
a first tightening nut, of the set of tightening nuts, is configured to adjust a position of the first clamp to cause the first clamp to contact the first region of the edge plate; and
a second tightening nut, of the set of tightening nuts, is configured to adjust a position of the second clamp to cause the second clamp to contact the second region of the edge plate.

20. The clamping assembly of claim 18, wherein the clamping assembly is configured to apply a clamping force on the edge plate when the first clamp contacts the first region of the edge plate and the second clamp contacts the second region of the edge plate,
wherein applying the clamping force facilitates lifting of the edge plate by the edge plate removal device.
